(19) United States
(12) Patent Application Publication
(10) Pub. No.: US 2006/0158678 A1
(43) Pub. Date: Jul. 20, 2006

(54) Document image capture and processing method and apparatus

(75) Inventor: George A. Angrick, Chicago, IL (US)

Correspondence Address: FITCH EVEN TABIN AND FLANNERY, 120 SOUTH LA SALLE STREET, SUITE 1600, CHICAGO, IL, 60603-3406, US

(73) Assignee: MediDal Corporation

(21) Appl. No.: 11/039,057

(22) Filed: Jan. 20, 2005

(51) Int. Cl. G06F 3/12

(52) U.S. Cl. 358/1.15

(57) ABSTRACT

An apparatus (200) has a document receiver (201) to receive a document and an image scanner (202) to facilitate capturing an image of that document. A data compressor (204) compresses the document image data and a transmitter (206) forwards the document image data to a predetermined processing center (302). These actions preferably occur in automated fashion in response to a trigger (209), thereby avoiding a need for a local user to interface with the apparatus much beyond simply presenting the document to the apparatus. Depending upon preference, encryption and post-capture image processing can also be provided. In a preferred approach, a local user output (212) provides status or other information to a local user.

### TECHNICAL FIELD

This invention relates generally to document processing and more particularly to image capture and related processing.

### BACKGROUND

Documents and written records of various kinds comprise an important foundation for many business, personal, and professional transactions and activities. Various technologies serve to facilitate the ease and/or speed by which a given document can be transferred from one location to another. For example, facsimile transmissions (more commonly referred to as fax transmissions) serve to electronically create a digitized image of a document and to then transmit that data to a compatible receiving machine where the data is then used to reconstruct an image of the original document in hardcopy format.

Typical document transmission technologies require a variety of user instructions and/or preferences. Such input can comprise, but is not limited to, information regarding a target address (such as the telephone number of a receiving fax machine), a time to transmit (such as “immediately” or at a specific later time), image characteristics, and so forth. In many cases such user interactions are relatively non-invasive and can be readily accommodated by the user. In other settings, however, such requirements tend to add undue delay and/or complications. In some cases requirements of this sort can even ultimately frustrate the entire process and cause the user to postpone the transaction or even seek alternative approaches.

For example, freight hauling operators, such as truck drivers, typically deal with a large number of documents as pertain to scheduled deliveries, completed deliveries, delivered inventories, contracts of various kinds, payment authorizations, and so forth. In many cases the truck driver first receives a given document while operating his/her vehicle. And in many cases it will be a considerable period of time before that truck driver is physically present at a terminal or other administrative center where the document can be properly processed. Delay in processing such documents, however, can pose significant burdens on the truck driver, including but not limited to delayed or refused payments, delayed or missed shipping opportunities, and so forth.

There are, to be sure, communications technologies that can assist persons such as truck drivers facing such circumstances. For example, wireless technologies exist that will permit a truck driver to wirelessly fax a scanned document to a corresponding processing center. In general, however, such existing solutions are inadequate to the need. For example, such solutions tend to require multiple platforms to effect the various steps of the process. This may be impractical at best (given, for example, the limited space available to a typical truck driver in their vehicle for such equipment) and unusable at worst (where, for example, the truck driver simply does not have the time, interest, or wherewithal to surmount the associated learning curve of operating these various platforms and of ensuring their compatible interaction with one another).

As another example, wireless link availability can and will vary as the truck driver's vehicle moves from place to place. As a result, the truck driver may not be able to effect an adequate transmission of the document at a convenient time and may be forced to attempt the process any number of times before a successful result is achieved. Such repeated attempts can be frustrating and detrimental to the business of the truck driver as they can become seriously diverting with respect to both time and attention requirements.

These problems can become considerably worse when other needs or preferences are taken into account. For example, encryption requirements or preferences can introduce yet another level of complexity and potential incompatibility as can data compression needs, image processing needs, and so forth. Other issues can arise with respect to batch transmission needs as may characterize certain work environments. As a general result, many of today's portable communications solutions continue to under serve in various and numerous ways the needs of numerous potential users such as truck drivers

### BRIEF DESCRIPTION OF THE DRAWINGS

The above needs are at least partially met through provision of the document image capture and processing method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, upon detecting a need to effect an image capture and forward process, a given platform can automatically capture a document (or documents) as an image, automatically compress that captured document image to provide a compressed image, and automatically forward that compressed image to a predetermined processing center.

In a preferred approach, these processes and actions are highly automated and require little or no action on the part of the user aside from asserting a user-assertable control interface and/or simply placing a document where it can be detected by such a process. Optionally, such a process can further provide for automated encrypting of the image data and/or other post-capture processing of choice.

Depending upon the needs or preferences of a given operator, such a process can provide for immediate (or as soon as possible) transmission of the image data or can provide for buffering of the image data in order to accommodate batch forwarding of the data image to the predetermined processing center.

In a preferred approach these various actions occur with very little user input being required and are further effected by a relatively integrated platform that uses little space or local resources to operate. If desired, local user information can be provided regarding one or more steps, stages, actions, and/or results of the process as it executes. Such local user information can assume any of a wide variety of forms including but not limited to audible information, visual information, and so forth.

So configured, the contents of a document can be readily transmitted via a portable platform that is small enough, and simple enough, to accommodate the physical and job-related requirements and restrictions of users such as truck drivers. With little or no required user interaction a document can be readily captured as a digitized image and processed as necessary or desired to suit the needs of a given application setting. That resultant image data can then be automatically conveyed to a predetermined processing center without further interaction on the part of the user being required.

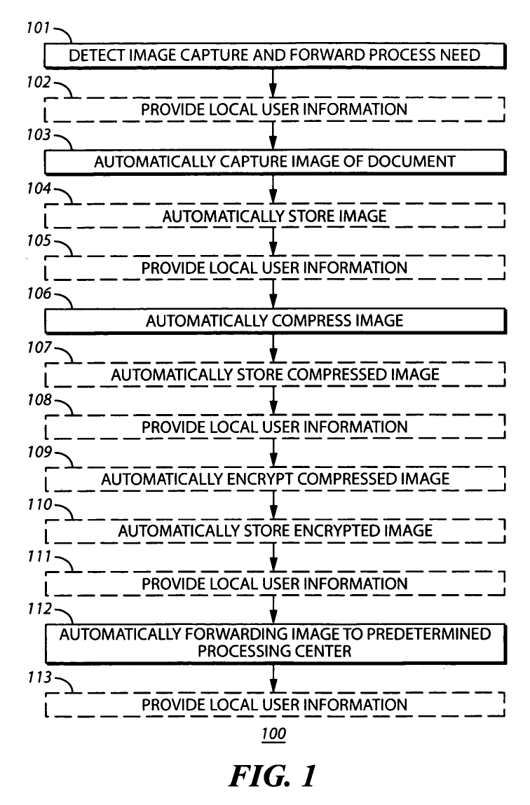

These and other benefits may become clearer upon making a thorough review and study of the following detailed description. Referring now to the drawings, and in particular to FIG. 1, a corresponding process 100 provides for detection 101 of a need to effect an image capture and forward process. Pursuant to one approach, this detection 101 can be based upon detecting an assertion of a user-assertable control interface (such as, but not limited to, assertion of a push button, a sliding or rotating switch, a touch sensitive display, a speech-recognition input, or the like). Pursuant to another approach, this detection 101 can be based upon simply detecting the presence of a document to be processed (with document detection techniques being a generally well-understood area of endeavor).

If desired, corresponding local user information can then be provided 102. The substantive information itself can reflect, for example, acknowledgement of having detected the indicated need and/or of having initiated or initialized the process 100. The information can be conveyed to a local user using any presently known or hereafter developed process or technique, including but not limited to audible information (such as specific tones, beeps, or the like and/or synthesized or prerecorded speech content), visible information (including but not limited to graphic information such as alphanumeric or iconic content as may be provided using, for example, a liquid crystal display or other display, indicator lights as may be provided using, for example, light emitting diodes, and so forth). In general, when provided, such local user information is not intended to necessarily prompt the user to effect a next step or to take a particular responsive action. Instead, such local user information is more typically preferably serving to update the user with respect to the proper (or improper) execution and operation of the process 100.

Upon detecting the indicated need, the process 100 then provides for automatically capturing 103 the document as an image to thereby provide a captured document image. This can be accomplished in various ways including through use of a TWAIN-based image acquisition component. Although a platform such as a flatbed scanner can be used for this purpose, an automatic document feed scanner is preferred. When seeking to accommodate close working quarters, a relatively small automatic document feed scanner is more likely to best serve these purposes. The image capture process itself can comprise a monochromatic or grayscale process (yielding a monochromatic or grayscale document image, respectively) or a full color process as desired. If desired, the captured image can be at least temporarily written to a Memory Mapped Queue as is known and understood in the art.

Also if desired, the image capture process can be preconfigured to only capture images as appear in certain predetermined portion of a submitted document, but more preferably all images as comprise a given document are automatically captured via this step. It would also be possible to automatically define an image capture area to exclude all non-image bearing areas. For ease of processing, however, it may be preferred to simply scan all portions of the document without regard for content analysis. The latter is particularly preferred when using an image capture platform that comprises a single pass platform that does not have a native automated capability that permits repeated scans of a given document.

For many purposes a simple image capture process will suffice. It may be desirable, however, to also include one or more post-capture processing steps as well. Such post-capture processing steps can include, for example, image enhancement processing (including but not limited to contrast adjustment, thresholds adjustment or setting, image rotation, image inversion, character recognition processing, shape recognition processing, pattern recognition processing, document identification processing, color reduction, and so forth, to name a few). Such post-capture processing can serve, for example, to facilitate selection of additional post-capture processing steps and/or can even serve to select a particular ultimate transmission destination from amongst a plurality of candidate destinations.

For many applications the captured image will be transmitted (as described below) immediately (or, in any event, as soon as possible or practical). For other applications, however, and particularly when accommodating a batch transmission/processing scheme, it may be desirable to temporarily buffer captured image data pending a delayed transmission window or activity. With that in mind, if desired, the initially captured document image (or a document image as has received at least some post-capture processing as suggested above) can optionally be automatically stored 104. When buffering such data pending a batch transmission, such image data will likely be buffered in conjunction with a plurality of other captured document images though other storage schemes can also be used or accommodated as appropriate.

Also, if desired, local user information can optionally be provided 105 to apprise a local user with respect to a present state of the process 100 or such other information as may be helpful to a local user.

This process 100 then provides for automatic compression 106 of the document image data to provide a compressed image (using, as but one example, Tagged Image File Format (TIFF) Group-4 compression). There are numerous compression techniques and algorithms presently known that may be employed for this purpose, and other approaches will no doubt be introduced in the future. Only a single approach to compression may be provided or, if desired, a dynamic selection process can be employed. For example, compression may be avoided completely when the original document image is relatively small. As another example, different levels of compression may be used at different times of day to accommodate predictable or ascertainable time-of-day differences with respect to costs of transmission and/or bandwidth availability.

Again, for the same reasons as were set forth above, one may chose to automatically store 107 the resultant compressed data image and/or provide 108 local user information as pertains to execution of the process 100 following this automated compression 106 of the document image. Those skilled in the art will recognize that, if buffering is preferred in support of delayed transmission for any reason, less memory will be required to buffer a compressed image than will be required to buffer the uncompressed document image. In general, then, automatically storing the document image following compression will typically be preferred to earlier storage.

When security comprises a relevant concern or preference, this process 100 can be optionally configured to automatically encrypt 109 the compressed document image. (If desired, of course, the data may be encrypted prior to compression but this can increase the complexities of recovering the clear data.) These teachings are compatible for use with essentially any known or hereafter developed encryption technique and hence may be applied in most if not all application settings.

As before, if desired, the resultant encrypted document image can be automatically stored 110 and/or corresponding local user information can be provided 111. With respect to the provision of local user information, either at this point in the process 100 or during any of the earlier mentioned optional opportunities, the local user information can comprise, if desired, information regarding network status (as pertains to the transmission media or pathway of choice), batch status (as pertains, for example, to the present quantity of buffered information and/or a next scheduled batch transmission, to note but a few), and so forth, in addition to process execution status information.

This process 100 then provides for automatically forwarding 112 the document image to a predetermined processing center. This forwarding can occur as soon as the document image is in suitable form to permit such forwarding (presuming availability of a transmission path) or can be postponed pending a subsequent transmission (such as, for example, a batch transmission as may be scheduled for a specific transmission window). The transmission itself can comprise any presently known or hereafter developed method including but not limited to the use of mobile telephony. When using mobile telephony, the transmission can be effected using standard telephony techniques or can be effected by using the services of, for example, a predetermined Internet service provider.

In general, and for the sake of simplicity, it may be preferred to provision the process 100 with only a single transmission target address. For example, only a single telephone number, such as a toll-free telephone number, may be provided for this purpose. In such a case, this one address will preferably correspond to the predetermined processing center of interest. If desired, however, this process 100 can have access to a plurality of target addresses. So provisioned, these addresses can be used, for example, in a round robin fashion to permit use of a next address when a selected address fails. As another example, a particular target address can be correlated to information that might be gleaned from the document image itself. To illustrate, post-capture processing of a document image may include pattern recognition that serves to recognize and distinguish between symbols. Based upon which symbol a given document might contain, a given correlated target address might facilitate automated direction of that document image to the corresponding predetermined processing center.

Following transmission of the document image (and/or following a failure to successfully effect such a transmission), again, local user information may be provided 113 to apprise a local user with respect to current status of the process 100, error conditions as may exist, and so forth.

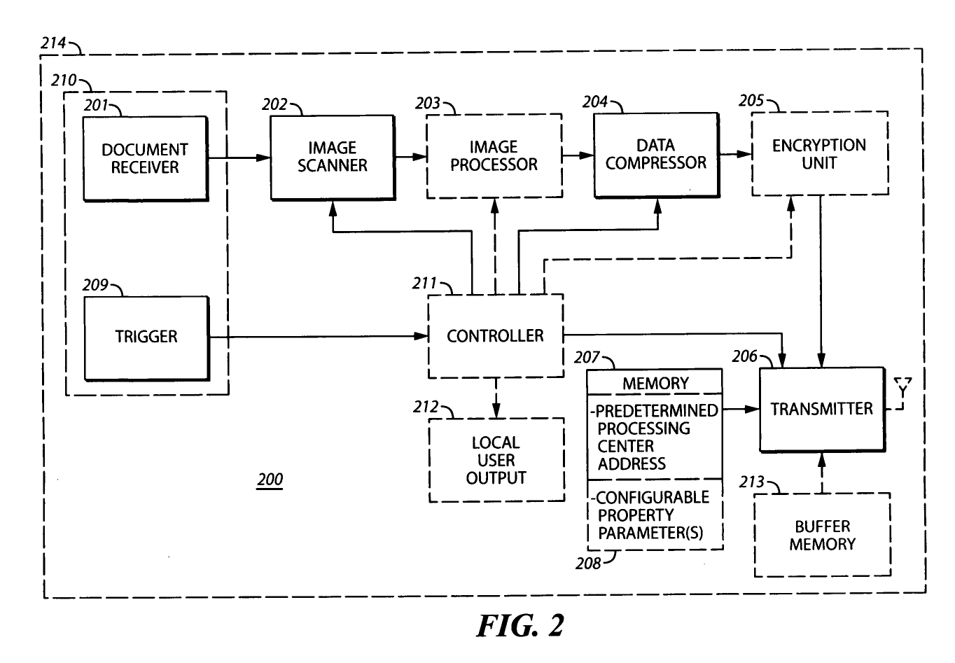

Such a process 100 can be realized via any number of platform configurations and embodiments. One compliant approach will now be described with reference to FIG. 2 to provide an illustrative example.

An exemplary apparatus 200 will preferably comprise a document receiver 201 that operably couples to (or is integral with) an image scanner 202. As mentioned above, such a component can comprise, for example, a flatbed document receiver or an automatic document feeder. Such components are well understood in the art and hence no further elaboration will be provided here for the sake of brevity and the preservation of narrative focus. A scanned document image output of the image scanner 202 in turn operably couples to a data compressor 204. Optionally, if desired, this can comprise a coupling via an image processor 203. When provided, the image processor 203 can effect such post-capture processing as may be desired and/or relevant to the supported application.

The compressed scanned document image output of the data compressor 204 operably couples to a transmitter 206. Optionally, if desired, this coupling can comprise an encryption unit 205 that serves to encrypt all or part of the incoming compressed scanned document image data. The transmitter 206 can comprise a wired or wireless interface. Depending upon preference the transmitter 206 can comprise a local area network interface or a wide area network interface (such as a mobile telephone interface). If desired, the transmitter 206 can comprise a pathway agile platform that is capable of compatible operation using more than one set of channel-defining characteristics (such as, for example, different frequencies or frequency bands, modulation techniques, multiplexing strategies, and so forth) or, if desired, more than one transmitter can be provided to assure compatible and selective transmission capabilities with a variety of systems and pathways.

Pursuant to a preferred approach the transmitter 206 operably couples to a memory 207 having at least one address for at least one predetermined processing center stored therein (such as, for example, a telephone number for a given Internet service provider and/or a specific end-user entity). Optionally, it may also be useful to store one or more configurable property parameters 208 in this memory 207 (such as but not limited to image acquisition source parameters, image transfer physical layer parameters (such as, for example, Open Systems Interconnection (OSI) layers 1 and 2), image transfer transport layer parameters (such as, for example, OSI layers 3 and 4), and/or image transfer session layer parameters (such as, for example, OSI layer 5), to name but a few) which may be used by the transmitter 206 to effect the intended scanned document image transmission while accommodating various protocols and network interfaces.

This apparatus 200 also preferably comprises a trigger 209 that operably couples to at least the image scanner 202, the data compressor 204, and the transmitter 206. This coupling can be direct or, if desired, can be effected via an entity such as an optional controller 211. The trigger 209 itself can comprise a user assertable control interface or can comprise, if desired, a part 210 of the document receiver 201 such that placement of a document in the document receiver 201 can cause an automated initiation of the previously described process 100 using the components of the apparatus 200.

The previously mentioned controller 211 can comprise a partially or wholly programmable platform that operably couples to one or more of the aforementioned components. The controller 211 preferably serves to respond to the trigger 209 by then causing automated sequential operation of the image scanner 202, the data compressor 204, and the transmitter 206 (along with any of the other optional components such as the image processor 203 and the encryption unit 205).

So configured, this apparatus 200 (particularly when deployed in conjunction with the aforementioned process 100) will cause automated operation of the described components in response to a single actuation of the trigger 209 such that a document is automatically scanned, processed as desired, compressed, encrypted as desired, and transmitted to a predetermined processing center. Depending upon the nature of the trigger 209 itself, this process is either largely or essentially wholly transparent to the user. In effect, if desired, a user need only place a document with the document receiver 201 and the described actions each automatically executes in sequential fashion to achieve the desired result.

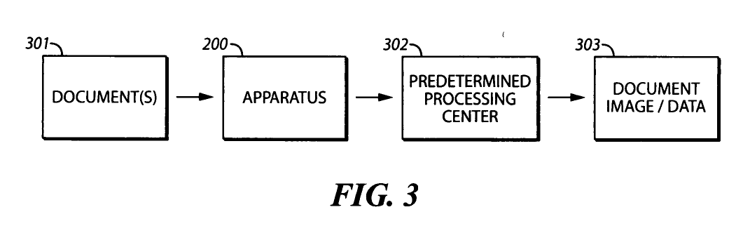

In particular, and with momentary reference to FIG. 3, a document 301 is delivered to the apparatus 200 by a user. That document is then automatically processed without further intervention being required on the part of the user (aside from possibly requiring the user to assert a process actuation signal). In particular, a properly configured image 303 of that document is delivered to a particular predetermined processing center 302 to facilitate and permit subsequent processing of the document's substantive content as desired.

As mentioned above, these teachings are compatible for use with batch transmission processes. To support such an approach, the apparatus 200 can further comprise a buffer memory 213 that receives a desired version of the scanned document image (i.e., the original image, a post-capture processed image, a compressed image, an encrypted image, and so forth as mentioned above). That buffered image data is then accessed and recovered when appropriate and transmitted along with such other buffered or current data as may otherwise be available and also intended for the batch transmission.

The above components can be deployed in a seriatim and discrete fashion if desired. It will also be understood that many of these components can share a common platform (such as a programmable platform having sufficient computational capacity and capability to support each such function). Preferably, a common housing 214 will be used to commonly house some or preferably all of the described components. As but one illustrative example, this housing 214 can comprise a briefcase-style housing. The document receiver/image scanner can be mounted on one inside surface of the housing and the remaining elements can be mounted and/or otherwise arrayed or stored on the opposing side of the housing. The transmitter 206 itself can be housed in this manner or can be external. An external coupling may be desired when the transmitter serves alternative purposes (such as when the transmitter comprises the user's mobile telephone).

So configured, the multi-faceted task of providing information regarding the substantive content of a hardcopy document to a specific location is greatly simplified. Virtually no training is required to achieve satisfactory performance under most conditions as virtually all tasks and functions occur transparently and without any particular need (or even opportunity) for intervention or guidance by the user. These embodiments are readily deployable in a concise form factor to thereby permit their usage in cramped quarters.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, it may be desirable to include a mechanism whereby a user can elect to halt or cancel the process (for example, by providing a halt and/or cancel user interface which, when asserted, effects the corresponding action with respect to execution of the described process). As another example, the document image forwarding action can incorporate an automated authentication process if desired. For example, the source apparatus may be required to present a specific user name and/or password in order to have its proffered document image received, accepted, and processed by the predetermined processing center.

We claim:

1. A method comprising:
detecting a need to effect an image capture and forward process;
automatically capturing a document as an image to provide a captured document image;
automatically compressing the captured document image to provide a compressed image;
automatically forwarding the compressed image to a predetermined processing center.

2. The method of claim 1 wherein detecting a need to effect an image capture and forward process further comprises detecting the document.

3. The method of claim 1 wherein detecting a need to effect an image capture and forward process further comprises detecting assertion of a user-assertable control interface.

4. The method of claim 1 wherein automatically capturing a document as an image further comprises using at least one of:
an automatic document feed scanner;
a flatbed scanner.

5. The method of claim 1 and further comprising providing information to a local user regarding at least one of detecting the need to capture an image, automatically capturing the image, automatically compressing the image, automatically forwarding the compressed image, network status, batch status, and error conditions.

6. The method of claim 5 wherein providing information to a local user further comprises providing audible information to a local user.

7. The method of claim 5 wherein providing information to a local user further comprises providing graphic information to a local user.

8. The method of claim 7 wherein providing graphic information to a local user further comprises providing graphic information to a local user using at least one of a liquid crystal display and at least one indicator light.

9. The method of claim 1 wherein automatically forwarding the compressed image to a predetermined processing center further comprises using mobile telephony to forward the compressed image.

10. The method of claim 9 wherein using mobile telephony to forward the compressed image further comprises automatically dialing a telephone number as corresponds to a predetermined Internet service provider.

11. The method of claim 1 wherein:
automatically compressing the image to provide a compressed image further comprising automatically encrypting the compressed image to provide an encrypted compressed image; and
automatically forwarding the compressed image to a predetermined processing center further comprises automatically forwarding the encrypted compressed image to a predetermined processing center.

12. The method of claim 1 wherein automatically capturing a document as an image to provide a captured document image further comprises effecting a post-capture process comprising at least one of:
image enhancement;
character recognition;
shape recognition;
pattern recognition;
document identification.

13. The method of claim 1 and further comprising:
storing information regarding a plurality of captured document images to provide buffered information;
and wherein automatically forwarding the compressed image to a predetermined processing center further comprises automatically batch forwarding the buffered information to the predetermined processing center.

14. An apparatus comprising:
a document receiver;
an image scanner operably coupled to the document receiver and having a scanned document image output;
a data compressor having an input operably coupled to the scanned document image output and having a compressed scanned document image output;
a memory having a address for a predetermined processing center stored therein;
a transmitter operably coupled to the memory and having an input operably coupled to receive the compressed scanned document image output;
a trigger operably coupled to the image scanner, the data compressor, and the transmitter;
such that a single actuation of the trigger causes automated operation of the image scanner, the data compressor, and the transmitter wherein a document is automatically scanned, compressed, and transmitted to the predetermined processing center.

15. The apparatus of claim 14 wherein the document receiver comprises one of:
an automatic document feeder;
a flatbed document receiver.

16. The apparatus of claim 14 wherein the trigger comprises a user assertable control interface, such that assertion of the user assertable control interface causes automatic scanning, compression, and transmission of a scanned image of the document to the predetermined processing center.

17. The apparatus of claim 14 wherein the trigger comprises a part of the document receiver, such that placement of the document in the document receiver causes automatic scanning, compression, and transmission of a scanned image of the document to the predetermined processing center.

18. The apparatus of claim 14 and further comprising an encryption unit having an input operably coupled to the scanned document image output and having an encrypted scanned document image output that is operably coupled to the input of the transmitter.

19. The apparatus of claim 14 wherein the transmitter comprises at least one of a mobile telephone interface, a wide area network interface, and a local area network interface.

20. The apparatus of claim 14 and further comprising a housing to substantially receive the document receiver, the image scanner, the data compressor, the memory, and the transmitter.

21. The apparatus of claim 14 and further comprising control means for responding to the trigger and for causing automated sequential operation of the image scanner, the data compressor, and the transmitter to effect automated provision of a scanned, compressed image of the document to the predetermined processing center.

22. The apparatus of claim 14 and further comprising an image processor having an input operably coupled to the image scanner and having an output operably coupled to the data compressor, wherein the image processor comprises at least one of:
an image enhancer;
a character recognition unit;
a shape recognition unit;
a pattern recognition unit;
a document identification unit.

23. The apparatus of claim 14 and further comprising:
a buffer memory operably coupled to receive compressed scanned document images and to provide a batch comprising at least one compressed scanned document image to the transmitter to facilitate batch transmissions.

24. The apparatus of claim 14 wherein the memory further has at least one configurable property parameter stored therein.

25. The apparatus of claim 24 wherein the at least one configurable property parameter comprises at least one of:
an image acquisition source parameter;
an image transfer physical layer parameter;
an image transfer transport layer parameter;
an image transfer session layer parameter.
